(19) United States
(12) Patent Application Publication
(10) Pub. No.: US 2017/0086424 A1
(43) Pub. Date: Mar. 30, 2017

(54) GARMENT FOR ANIMAL

(71) Applicants: Robert Blanchet, Toronto (CA); Paula Moreau, Toronto (CA)

(72) Inventors: Robert Blanchet, Toronto (CA); Paula Moreau, Toronto (CA)

(21) Appl. No.: 15/275,998

(22) Filed: Sep. 26, 2016

Related U.S. Application Data
(60) Provisional application No. 62/232,826, filed on Sep. 25, 2015.

(51) Int. Cl. A01K 13/00

(52) U.S. Cl. CPC A01K 13/007

(57) ABSTRACT

An animal garment comprises a front portion comprising a front body member, and a pair of front leg segments extending from the front body member; and a rear portion comprising a second body member, and a pair of rear leg segments extending from the rear body member. Each of the leg segments has a boot affixed to an end thereof. The front portion and the rear portion are removably connectable to each other by one or more fasteners.

### CROSS-REFERENCE TO RELATED APPLICATION

This application claims the benefit of U.S. Application No. 62/232826 filed on Sep. 25, 2015, the entire content of which is incorporated herein by reference in its entirety.

### FIELD

The subject disclosure relates generally to garments, and in particular to a garment for an animal.

### BACKGROUND

Walking barefoot on the ground can be difficult for a pet's feet, and particularly a dog's feet, under adverse ground conditions. These conditions may include cold temperatures, hot pavement, broken glass fragments or other sharp or foreign objects, and salt or chemicals on the ground. Pet owners typically wish to protect their pets from these conditions, as the pet can incur problems while walking in such conditions, such as discomfort and damage to the pet's feet. The damage may be chapping, cracking, splitting, bleeding, infection, and the like.

To avoid discomfort and damage to the pet's feet, pet owners may need to carry their pets. Alternatively, pet owners can place boots or slippers on the pet's feet to prevent direct contact of the pet's feet with the ground.

Unfortunately, these boots or slippers can come off either partially or entirely during use, which can in turn result in discomfort to the pet and damage to its paws. Additionally, boots or slippers that have come off are easily lost, requiring the pet owner to incur the cost of purchasing a new set.

Pets themselves may find the boots or slippers to be uncomfortable, and may attempt to remove the boots or slippers themselves using their teeth or paws. This can also cause the boots or slippers to become lost.

The boots or slippers typically have a tighter portion around the ankle of the pet. The tighter portion is intended to prevent the boot from easily coming off. However, as a result of the tighter portion, the boots or slippers can be tedious and difficult to put on. This can be particularly problematic when the pet is eager to get outside. Additionally, the pet's claws can easily snag on the tighter portion as the pet's paw is being inserted into the boot or slipper. To avoid such damage, the pet's paw typically needs to be squeezed together in order to fit through the tighter portion, which causes inconvenience to the pet and owner.

Garments for animals have been described. For example, U.S. Pat. No. 5,359,963 to Jesse et al. describes a dog sweater comprising a fabric torso portion and a lower portion for covering the body of a dog in inclement weather. A first aperture extends through the front end of the fabric torso portion for accepting a dog's head. A neck collar for covering a dog's neck is positioned about and integral with the first aperture. A second opening extends through the posterior end of the fabric torso portion for enabling a dog to eliminate bodily waste without soiling the fabric torso portion. A pair of apertures at the front lower portion and a pair of apertures at the posterior lower portion of the fabric torso portion receive the fore and rear limbs of a dog, respectively. A sleeve is integral with and extends downwardly from each aperture at the lower portion of the torso portion. The sleeves have an upper end, a lower end and fabric extending between for protecting the upper portion of a dog's limbs. A leg collar is positioned about, and integral with, the bottom end of each sleeve. A legging having a top and bottom end, an exterior surface, and an interior surface is detachably coupled to the lower end of each leg sleeve for protecting the lower portion of the fore and rear legs of a dog from the elements.

Canadian Patent Application No. 2,701,926 to Foster describes a “Suspend-A-Boot” product for keeping dog boots or shoes on so that, in the event that the boots or shoes come off, they will remain attached and not be lost. The product comprises four elastic straps extending from the center of a dog's back to the ankles. The elastic straps are adjustable for each leg, and are attached at the top of the dog's back by a strip of webbing that also is adjustable according to the length of the animal's back. Each strap has a plastic slip lock buckle for adjusting. A plastic slip lock buckle on the strap that attaches to the collar, as well as a plastic slip lock buckle on the webbing at the top of the dog's back that can be used for adjusting the webbing. The straps are attached by D rings to a main support at the top. At the bottom of each leg strap is a metal clip with a D ring.

U.S. Patent Application Publication No. 2014/0053790 to Rumps describes an integrated pet outfit that combines pet clothing with pet shoes, and provides protection against inclement weather and outdoor elements as well as reducing the transmission of dirt and grime from outdoors into the owner's home. The integration of a body covering, leggings and shoes minimizes exposure to the elements and prevents the loss or accidental removal of individual shoes.

Improvements are generally desired. It is an object at least to provide a novel garment for an animal.

### SUMMARY

Accordingly, in one aspect there is provided an animal garment, comprising: a front portion comprising a front body member, and a pair of front leg segments extending from the front body member; and a rear portion comprising a second body member, and a pair of rear leg segments extending from the rear body member, each of the leg segments having a boot affixed to an end thereof, wherein the front portion and the rear portion are removably connectable to each other by one or more fasteners.

The one or more fasteners may be patches of hook-and-loop material.

The animal garment may further comprise a neck strap extending from the front body member. The neck strap may comprise a first strap portion and a second strap portion, the first strap portion and the second strap portion being removably connectable to each other by one or more neck strap fasteners.

One or more of the leg segments may comprise a strip of elastic material fastened thereto. The strip of elastic material may be fastened to an inside of the leg segment. The strip of elastic material is positioned adjacent a knee joint of the animal.

One or both of the front body member and the rear body member may comprise a stretchable patch fastened thereto. The front body member or the rear body member may comprise a cutout accommodating the stretchable patch.

The animal garment may further comprise a connector strap sized to provide a handle. The connector strap may be affixed to one of the front body member and the rear body member. The connector strap may a loop affixed thereto, the loop being configured to provide a point of connection for a leash clip or a lead. The loop may be a ring.

The boot may comprise: a sole; and a first flap and a second flap connected to the sole and extending from the leg segment, the first flap and the second flap being configured to be removably connected to each other. The first flap and the second flap may be configured to provide an opened configuration for insertion of a paw, and a closed configuration for securing the boot around the paw and lower ankle of the animal. The first flap and the second flap may be configured to be removably connected to each other by one or more fasteners.

### BRIEF DESCRIPTION OF THE DRAWINGS

Embodiments will now be described more fully with reference to the accompanying drawings in which:

FIG. 1 is a side view of an animal garment, being worn by an animal in use;

FIG. 2 is an exploded top view of the animal garment of FIG. 1;

FIG. 3 is an exploded bottom view of the animal garment of FIG. 1;

FIG. 4 is a view of a boot forming part of the animal garment of FIG. 1, in an opened configuration;

FIG. 5 is an opposite-side view of the boot of FIG. 4, in a closed configuration;

FIG. 6 is a schematic view of the boot of FIG. 4; and

FIG. 7 is a side view of another embodiment of an animal garment, being worn by an animal in use.

### DETAILED DESCRIPTION OF EMBODIMENTS

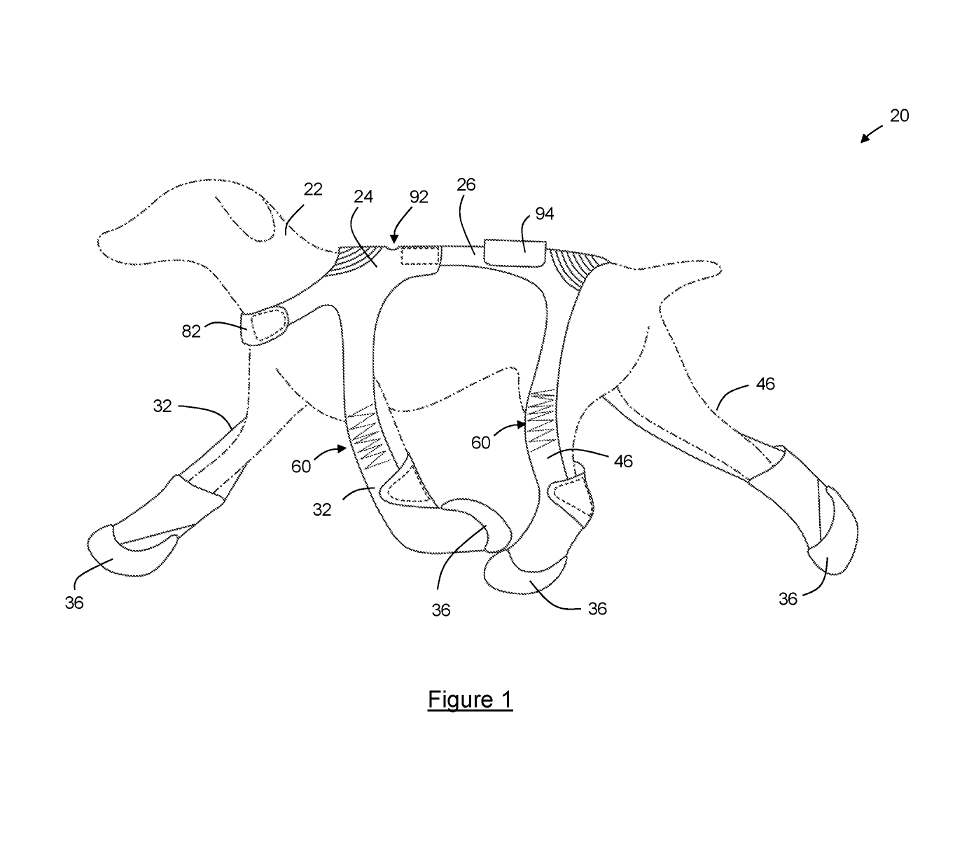

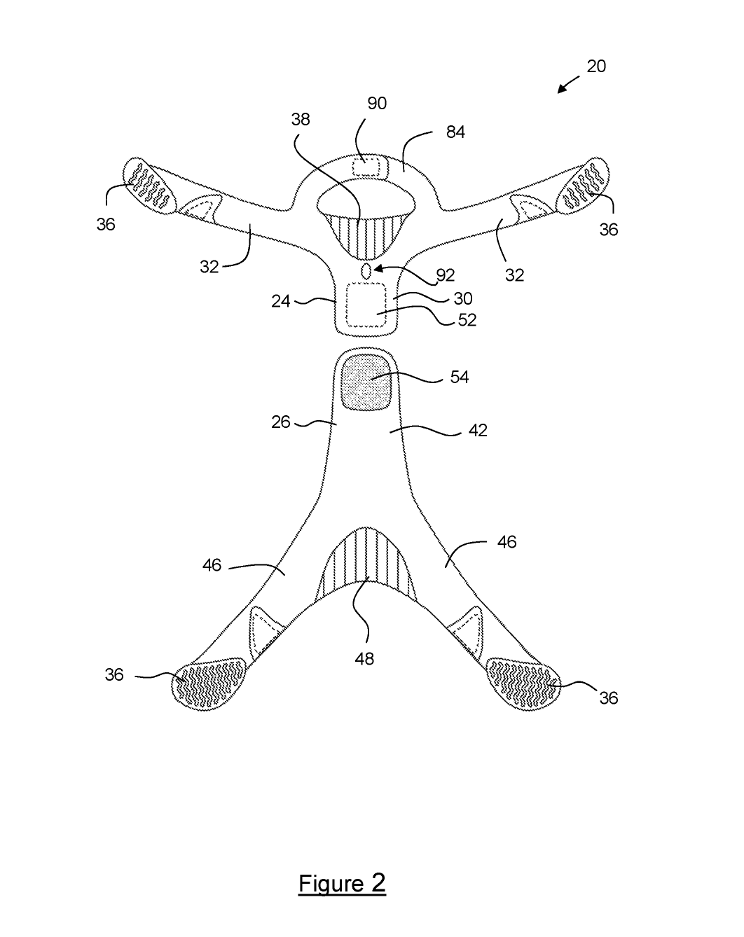

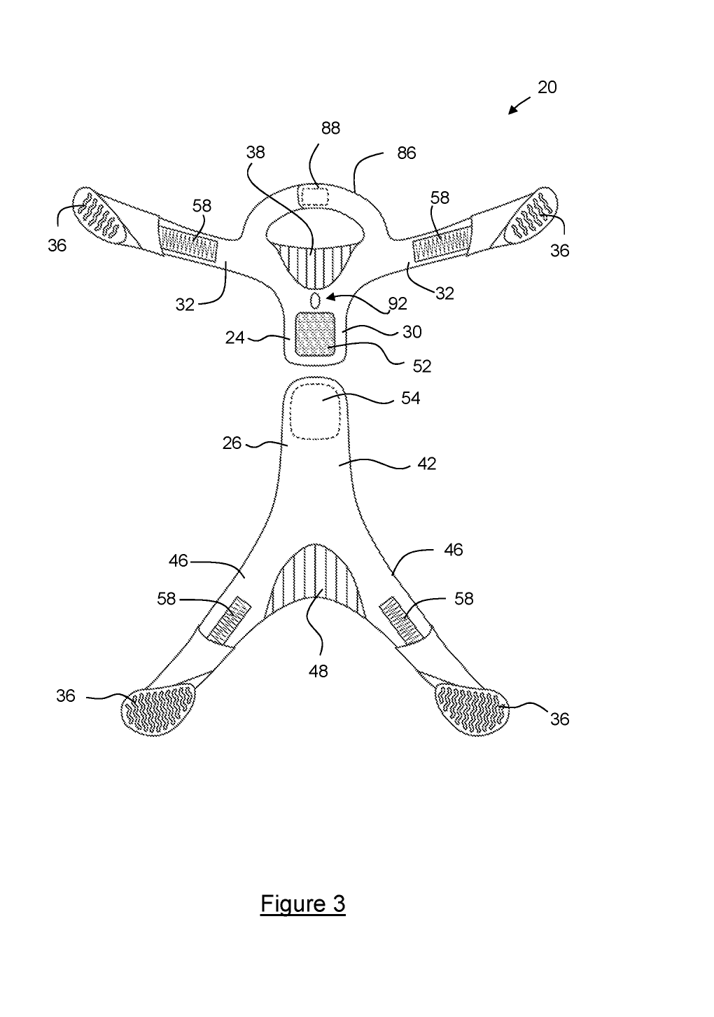

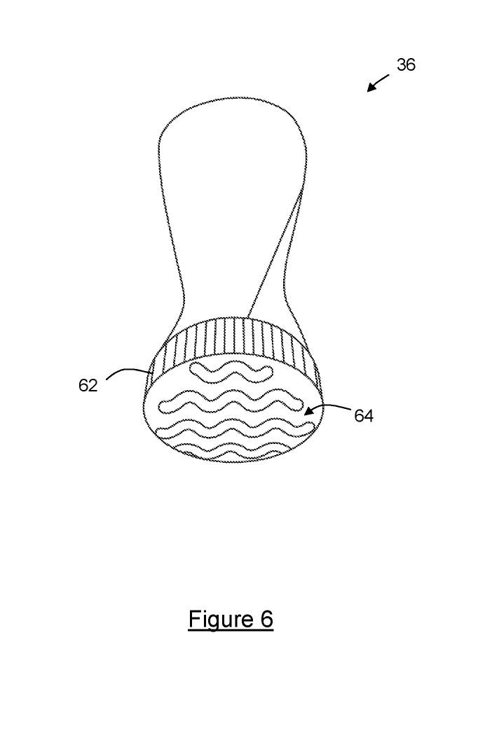

Turning now to FIGS. 1 to 6, an animal garment is shown and is generally indicated by reference numeral 20. Animal garment 20 is configured to be worn by an animal 22 that walks on four (4) legs, and is generally configured to provide protection and comfort to paws (not shown) of the animal 22 when the animal 22 walks, runs, and the like, under adverse conditions. These adverse conditions may include cold temperatures, hot pavement, slippery ground surfaces, broken glass fragments or other sharp or foreign objects scattered on the ground, and salt or chemicals on the ground, and the like. In the embodiment shown, the animal 22 is a dog, but the garment 20 may also be worn by other kinds of four-legged animal.

The garment 20 comprises a front portion 24 and a rear portion 26. The front portion 24 and the rear portion 26 are fabricated of resilient materials that feel generally comfortable to the animal 22 during use.

The front portion 24 comprises a front body member 30, and a pair of front leg segments 32 extending from the front body member 30. At the end of each front leg segment 32 is attached a boot 36 configured to accommodate a paw of the animal 22. The front body member 30 has a stretchable patch 38 fabricated of stretchable material that is fastened thereto adjacent the back of the neck of the animal 22. The stretchable patch 38 allows the front portion 24 to stretch, as needed, to provide a snug fit on the neck of the animal 22. In this embodiment, the stretchable material is a ribbing material comprising pleats oriented along the length of the animal to provide an “accordion” configuration that is particularly expandable in the width direction of the animal; however in other embodiments, other stretchable material(s) may alternatively be used. Also in this embodiment, the stretchable patch 38 covers a cutout formed in the front body member 30.

The rear portion 26 comprises a rear body member 42, and a pair of rear leg segments 46 extending from the rear body member 42. At the end of each rear leg segment 46 is attached a boot 36 configured to accommodate a paw of the animal 22. The rear body member 42 has a stretchable patch 48 of stretchable material fastened thereto near the tail of the animal 22. The stretchable patch 48 allows the rear portion 26 to stretch, as needed, to provide a snug fit around the rear of the back of the animal 22. In this embodiment, the stretchable material is the ribbing material comprising the pleats oriented along the length of the animal to provide the “accordion” configuration described above; however in other embodiments, other stretchable material(s) may alternatively be used. Also in this embodiment, the stretchable patch 48 covers a cutout formed in the rear body member 42.

The front portion 24 and the rear portion 26 are configured to be removably connected to each other by one or more fasteners. In this embodiment, the one or more fasteners are patches of hook-and-loop material (such as Velcro™), and more specifically, a first patch 52 of hook-and-loop material attached to the front body member 30 of the front portion 24, and a second patch 54 of opposing hook-and-loop material attached to the rear body member 42 of the rear portion 26. Bringing the first patch 52 and the second patch 54 into contact with each other causes the patches 52 and 54 (and in turn, the front and rear portions 24 and 26) to become removably connected to each other.

The front leg segments 32 and the rear leg segments 46 each have a strip 58 of elastic material fastened thereto. In the embodiment shown, each strip 58 of elastic material is fastened to the inside of the leg segment 32 or 46, and is located at a position of the leg segment 32 or 46 that is adjacent a knee joint of the animal 22 during use. Each strip 58 of elastic material induces bunching 60 or “gathering” of the leg segment 32 or 46 around the knee joint. As will be appreciated, the bunching 60 prevents the leg segment 32 or 46 from hanging limp or flapping loosely during use, while allowing elastic extension of the leg segment 32 or 46 as needed when the animal 22 extends its leg, or when the garment 20 is worn by a larger animal, for example. As can be seen, the strip 58 of elastic material extends only a portion of the length of each leg segment.

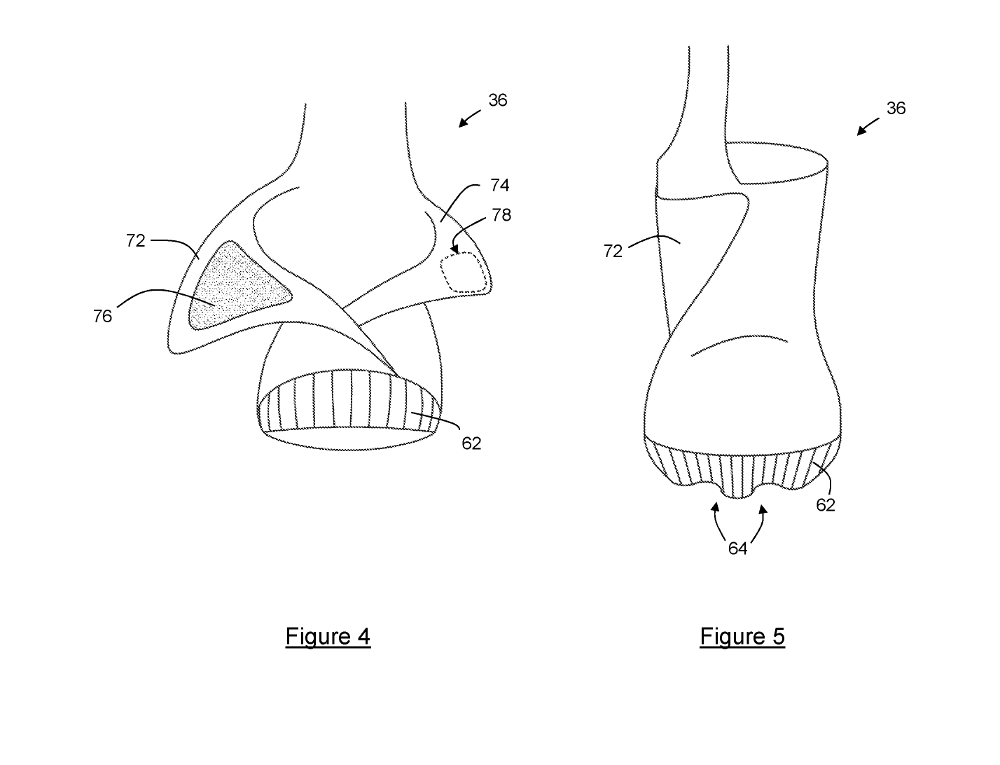

One of the boots 36 is shown in FIGS. 4 to 6. Each boot 36 comprises a sole 62 fabricated of a durable, resilient material, and is configured to provide cushioning and comfort, while also providing a durable and waterproof barrier, to the paw of the animal 22 during use. In this embodiment, the sole 62 is fabricated of rubber. The sole 62 comprises a grooved tread 64 for providing grip. The grooved tread 64 of the boot 36 form tracks when the animal 22 steps on soft ground (such as snow, mud and sand, for example) during use, and the tread pattern of the grooved tread 64 can be designed and selected to provide recognizable tracks, as desired. Each boot 36 also comprises a first flap 72 and a second flap 74, which extend outwardly from each leg segment 32 or 46 and which are attached to the sole 62 by stitching, and/or gluing, and the like. The first flap 72 and the second flap 74 are configured to be removably connected to each other to provide an opened configuration and a closed configuration. In the opened configuration, the first flap 72 and the second flap 74 separate to define a wide opening through which the paw can be easily inserted or removed. In the closed configuration, the first flap 72 at least partially overlaps and connects to the second flap 74, such that the boot 36 is secured around the paw and at least the lower ankle of the animal 22. In the example shown, the first flap 72 and the second flap 74 are positioned on the boot 36 such that the opening is at the side of the boot 36, however in other embodiments the first and second flaps may be positioned such that the opening is at the rear or at the front of the boot. In the example shown, the first flap 72 is sized to extend around about one-half the circumferential distance of the ankle of the animal 22, however, in other embodiments the first flap may be sized to extend around another circumferential distance. The size and configuration of the first flap 72 advantageously eliminates the need for the boot 36 to otherwise require one or more additional fastening straps, as in boots of conventional animal garments. The first flap 72 and the second flap 74 are configured to be removably connected to each other by one or more fasteners. In this embodiment, the one or more fasteners are patches of hook-and-loop material (such as Velcro™), and more specifically, a first patch 76 of hook-and-loop material attached to an inside of the first flap 72 and a second patch 78 of opposing hook-and-loop material attached to an outside of the second flap 74.

The front portion 24 also comprises a neck strap 82 configured to secure the front portion 24 around the neck of the animal 22. The neck strap 82 comprises a first strap portion 84 and a second strap portion 86. The first strap portion 84 and the second strap portion 86 are configured to be removably connected to each other around the neck of the animal 22 by one or more fasteners. In this embodiment, the one or more fasteners are patches of hook-and-loop material (such as Velcro™), and more specifically, a first patch 88 of hook-and-loop material attached to the first strap portion 84 and a second patch 90 of opposing hook-and-loop material attached to the second strap portion 86.

The front portion 24 has an aperture 92 formed therein, with the aperture 92 having the general form of a “button hole” encircled by reinforcement stitching (not shown). The aperture 92 is sized to receive a connection ring (not shown) forming part of a collar (not shown) or harness (not shown) worn by the animal 22 under and/or simultaneously with the front portion 24. The connection ring is configured to provide a point of connection for a leash clip (not shown) or a lead clip (not shown), for example. The rear portion 26 has a pocket 94 affixed thereto. The pocket 94 is sized to contain one or more accessory items, such as an empty bag or a full bag of animal waste, or a coiled leash, for example. The pocket 94 may be accessed by opening and closing a flap (not shown).

In this embodiment, the front body member 30, the front leg segments 32, the rear body member 42, the rear leg segments 46, and the first flap 72 and the second flap 74 of each boot 36, and the first strap portion 84 and the second strap portion 86 of the neck strap 82, are all fabricated of neoprene sheet, however in other embodiments, at least one of these elements may alternatively be fabricated of one or more other materials. As will be appreciated, by this construction, the front body member 30, front leg segments 32, and the first flap 72 and the second flap 74 of each boot 36 attached thereto, have an effectively integral construction. Similarly, and as will be appreciated, by this construction, the rear body member 42, the rear leg segments 46, and the first flap 72 and the second flap 74 of each boot 36 attached thereto, have an effectively integral construction.

In use, the garment 20 is put onto the animal 22 with the front portion 24 and the rear portion 26 already connected to each other and, in no particular order, in accordance with the following steps. The front body member 30 and the rear body member 42 are placed onto the back of the animal 22. The neck strap 82 is secured around the neck of the animal 22 by separating the first strap portion 84 and the second strap portion 86, placing the first and second strap portions 84 and 86 around the neck of the animal 22, and securing the portions 84 and 86 together using the fasteners. The leg segments 32 and 42 are positioned generally adjacent the legs of the animal 22. Each boot 36 is opened, if not already open, by separating the first flap 72 and the second flap 74. Each paw of the animal 22 is then inserted into its respective opened boot 36 through the opening, defined by the separated first and second flaps 72 and 74; with the paw inserted, each boot 36 is secured around the paw and at least the lower ankle of the animal 22 by connecting the first flap 72 and the second flap 74 together. The connection ring of a collar or harness worn by the animal is fed through the aperture 92, thereby providing a point of connection for a leash clip or a lead clip.

Alternatively, in use, the garment 20 may be put onto the animal 22 by putting each of the front portion 24 and the rear portion 26 onto the animal 22 separately, and then connecting the front portion 24 and the rear portion 26 together using the fasteners, in addition to steps provided above.

As will be appreciated, by having the front portion 24 and the rear portion 26 removably connectable to each other, and therefore separable from each other, the same garment 20 may advantageously be adjusted to fit animals 22 of different size. Moreover, by using patches of hook-and-loop material as fasteners, the front portion 24 and the rear portion 26 may advantageously be connected to and separated from each other quickly and in a facile manner.

Additionally, and as will be appreciated, the configuration of each boot 36 provides a wide opening when the boot 36 is in the opened configuration. This wide opening allows the paw of the animal 22 to be inserted into the boot 36 in quickly and in a facile manner, and without requiring the paw to be compressed in order to otherwise prevent snagging of the claw(s) and causing tearing. In the event that one or more claws do become snagged during insertion into the boot 36, the absence of any “tight portion” in the boot 36 eliminates the risk of the claw(s) experiencing forces that would otherwise cause tearing or damage to the claw(s); rather, the first flap 72 and a second flap 74 hang loosely when the boot 36 is in the opened configuration and do not present any restriction. Moreover, by using patches of hook-and-loop material as fasteners, the first flap 72 and a second flap 74 may advantageously be connected to each other quickly and in a facile manner once the paw has been inserted.

As will be appreciated, the stretchable patches 38 and 48 allow the front and rear portions 24 and 26 to stretch, as needed. The stretchable patches 38 and 48 advantageously provide a snug fit on the neck and near the tail of the animal 22 in an “automatic” manner, and without requiring the owner to otherwise manually loosen or tighten any other buckles, straps or fastening elements located at these positions.

These advantageous features allow the garment 20 to be put on the animal 22 with greater convenience, as compared to conventional animal garments.

Additionally, and as will be appreciated, as the boots 36 are integrally connected to the front and rear leg segments 32 and 46, the boots 36 advantageously cannot be separated from the garment 20 and otherwise become lost.

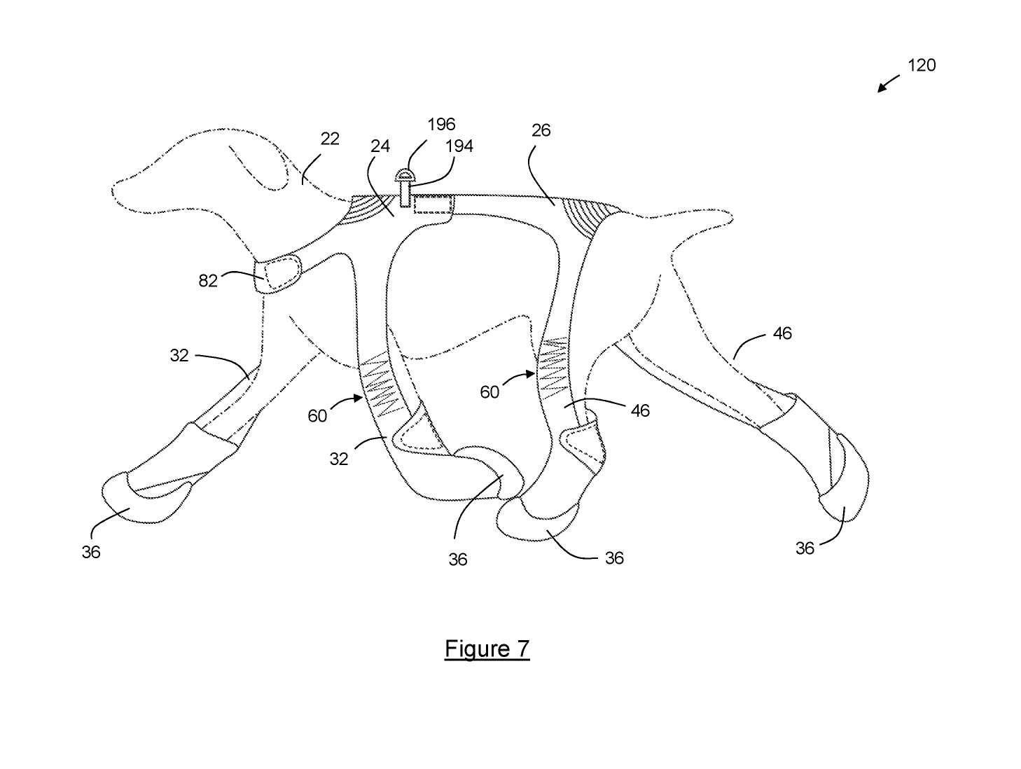

Other configurations are possible. For example, FIG. 7 shows another embodiment of an animal garment, which is generally indicated by reference numeral 120. Animal garment 120 is similar to animal garment 20 described above with reference to FIGS. 1 to 6, but comprises a connector strap 194 attached to the front portion 24. The connector strap 194 is sized to provide a handle, in the event that the animal 22 needs to be lifted or restrained by a person, such as an owner. The connector strap 194 has a loop 196 affixed thereto, which is configured to provide a point of connection for a leash clip or lead, for example. In the example shown, the loop 196 is a “D-shaped” ring fabricated of metal or plastic. The garment 120 shown in FIG. 7 does not comprise any aperture 92.

In other embodiments, the connector strap 194 may alternatively be attached to the rear portion 26.

Although in an embodiment described above, the garment comprises a pocket, in other embodiments, the garment may alternatively comprise no pocket, or may alternatively comprise multiple pockets.

Although in the embodiments described above, the fasteners are patches of hook-and-loop material, in other embodiments, one or more other types of fasteners may alternatively be used. For example, in other embodiments, one or more of the fasteners may be one or more clips, one or more belt/buckle systems, one or more clasps, and the like. Still other types of fasteners may alternatively be used.

Although in the embodiments described above, the front body member 30, front leg segments 32, and the first flap 72 and the second flap 74 of each boot 36 attached thereto are fabricated of the same material so as to have an effectively integral construction, in other embodiments, one or more of the front body member 30, front leg segments 32, and the first flap 72 and the second flap 74 of each boot 36, may alternatively be fabricated of different materials that are affixed to each other (e.g. by stitching, gluing and the like). Similarly, although in the embodiments described above, the rear body member 42, the rear leg segments 46, and the first flap 72 and the second flap 74 of each boot 36 attached thereto are fabricated of the same material so as to have an effectively integral construction, in other embodiments, one or more of the rear body member 42, the rear leg segments 46, and the first flap 72 and the second flap 74 of each boot 36, may alternatively be fabricated of different materials that are affixed to each other (e.g. by stitching, gluing and the like).

Although in the embodiments described above, the garment comprises elastic strips on each leg segment, in other embodiments, one or more of the leg segments may alternatively have no elastic strip affixed thereto.

Although embodiments have been described above with reference to the accompanying drawings, those of skill in the art will appreciate that variations and modifications may be made without departing from the scope thereof as defined by the appended claims.

What is claimed is:

1. An animal garment, comprising:
a front portion comprising a front body member, and a pair of front leg segments extending from the front body member; and
a rear portion comprising a second body member, and a pair of rear leg segments extending from the rear body member,
each of the leg segments having a boot affixed to an end thereof,
wherein the front portion and the rear portion are removably connectable to each other by one or more fasteners.

2. The animal garment of claim 1, wherein the one or more fasteners are patches of hook-and-loop material.

3. The animal garment of claim 1, further comprising a neck strap extending from the front body member.

4. The animal garment of claim 3, wherein the neck strap comprises a first strap portion and a second strap portion, the first strap portion and the second strap portion being removably connectable to each other by one or more neck strap fasteners.

5. The animal garment of claim 1, wherein one or more of the leg segments comprises a strip of elastic material fastened thereto.

6. The animal garment of claim 5, wherein the strip of elastic material is fastened to an inside of the leg segment.

7. The animal garment of claim 5, wherein the strip of elastic material is positioned adjacent a knee joint of the animal.

8. The animal garment of claim 1, wherein one or both of the front body member and the rear body member comprises a stretchable patch fastened thereto.

9. The animal garment of claim 8, wherein the front body member or the rear body member comprises a cutout accommodating the stretchable patch.

10. The animal garment of claim 1, further comprising a connector strap sized to provide a handle.

11. The animal garment of claim 10, wherein the connector strap is affixed to one of the front body member and the rear body member.

12. The animal garment of claim 10, wherein the connector strap has a loop affixed thereto, the loop being configured to provide a point of connection for a leash clip or a lead.

13. The animal garment of claim 12, wherein the loop is a ring.

14. The animal garment of claim 1, wherein the boot comprises:
a sole; and
a first flap and a second flap connected to the sole and extending from the leg segment, the first flap and the second flap being configured to be removably connected to each other.

15. The animal garment of claim 14, wherein the first flap and the second flap are configured to provide an opened configuration for insertion of a paw, and a closed configuration for securing the boot around the paw and lower ankle of the animal.

16. The animal garment of claim 14, wherein the first flap and the second flap are configured to be removably connected to each other by one or more fasteners.
